(19) United States
(12) Patent Application Publication
(10) Pub. No.: US 2010/0077004 A1
(43) Pub. Date: Mar. 25, 2010

(54) Interactive educational program having dynamic data fields and method of exchanging same

(76) Inventors: Glenn Abel, San Diego, CA (US); Andrew Wolfe, (US)

Correspondence Address: THE MATTHEWS FIRM, 2000 BERING DRIVE, SUITE 700, HOUSTON, TX, 77057, US

(21) Appl. No.: 12/584,381

(22) Filed: Sep. 4, 2009

Related U.S. Application Data
(60) Provisional application No. 61/191,277, filed on Sep. 5, 2008.

(51) Int. Cl. G06F 17/30

(52) U.S. Cl. 707/781; 707/E17.005

(57) ABSTRACT

Systems and methods for disseminating data to users and enabling user customization of the data are disclosed herein. Access to the database is provided to one or more user devices, which are usable to select one or more items of data. Upon receiving a selection of one or more items of data, one or more customized notes can be received from a user device and stored in association with the selected data. Each note can be provided with a designation which selectively controls whether viewing of the note is permitted to all other users, or whether viewing of the note is restricted to the user from which it originated or users within a selected user group. A note screen containing all viewable notes associated with a selected item of data can thereby transmitted to the user device.

### CROSS REFERENCE TO RELATED APPLICATIONS

The present application claims priority to the U.S. provisional patent application having the Ser. No. 61/191,277, filed Sep. 5, 2008, the entirety of which is incorporated herein by reference.

### FIELD

The present invention relates, generally, to methods and systems for disseminating data to one or more users for review, and for enabling user customization of the data.

### BACKGROUND

The Internet and the World Wide Web are rapidly expanding, with businesses and individuals using their own Web pages. This has created a demand for richer Web page capabilities especially in the area of coordinated presentations and control of multimedia events, including being able to easily synchronize the execution of a plurality of multimedia events over a period of time by coordinating multimedia presentations. Because not all Web page owners are sophisticated computer users, the design and programming of Web pages must remain simple. Further, the synchronizing of multimedia events within a Web page should not require complicated or lengthy user programs. Instead, implementing and controlling a Web page should be intuitive and “user-friendly” while still providing sophisticated capabilities, such as synchronizing and coordinating animations during a sequence.

Web pages are composed of various multimedia elements, controls, and applets as defined by the Hypertext Markup Language (HTML) for a given Web page. Multimedia can be characterized as some combination of visual media, audio media and time. Multimedia is an open environment, with timing being the common thread across all multimedia events. Multimedia experiences, such as the movement of physical models, graphics and the playing of sound, require coordinated execution of these events from different perspectives. For instance, the playing of a medical procedure or event can be viewed from various perspectives to enable the viewer to fully appreciate the procedure or event. For example, the presentation of a medical procedure or something as simple as viewing a broken wrist can be much better appreciated if viewed from various perspectives simultaneously. In the case of the broken wrist, additional fractures may not be viewable from a single perspective.

Providing synchronized multimedia experiences is complicated because timing control information is not inherent in the content of an HTML document. Past attempts at providing such synchronization and coordination of activities within a Web page have basically take on one of several forms, such as for example, (1) external programs and (2) lengthy, complicated scripts or programs. These solutions generally are non-user-friendly, require additional hardware resources, software resources and/or expenses, and do not provide true synchronization of events. Additionally, other approaches have not allowed synchronization and coordination between or among animations.

### BRIEF DESCRIPTION OF THE DRAWINGS

In the detailed description of various embodiments of the present invention presented below, reference is made to the accompanying drawings, in which:

FIG. 1 depicts a diagram of an embodiment of a portion of a database and an associated note page accessible by a first user device associated with a user account.

FIG. 2 depicts a diagram of an embodiment of the portion of the database depicted in FIG. 1 and an associated note page accessible by a second user device.

FIG. 3 depicts a diagram of an embodiment of the present system.

FIG. 4 depicts a flowchart demonstrating an embodiment of an aspect the present method through which items of data can be modified and disseminated to users.

FIG. 5 depicts a flowchart demonstrating an alternate embodiment of an aspect the present method through which items of data can be modified and disseminated to users.

FIG. 6 depicts an embodiment of an exemplary screen display usable to facilitate access to one or more elements of the present system.

FIG. 7 depicts the exemplary screen display of FIG. 6 having an updated and/or modified item of data accessible to one or more users.

FIG. 8 depicts the exemplary screen display of FIG. 7 when displaying a preceding version of one or more items of data rather than the most current and/or modified version.

FIG. 9 a flowchart demonstrating a further embodiment of an aspect the present method through which items of data can be modified and disseminated to users.

FIG. 10 depicts an embodiment of an exemplary screen display usable to facilitate access to one or more elements of the present system.

FIG. 11 depicts the exemplary screen display of FIG. 10 having an updated and/or modified item of data accessible to one or more users.

FIG. 12 depicts the exemplary screen display of FIG. 11 when displaying a preceding version of one or more items of data rather than the most current and/or modified version.

FIG. 13 depicts a flowchart demonstrating an embodiment of an aspect the present method through which items of data can be modified and disseminated to users.

FIG. 14 depicts an embodiment of an exemplary screen display usable to facilitate access to one or more elements of the present system.

FIG. 15 depicts the screen display of FIG. 14 after selection of an item of data.

FIG. 16 depicts the exemplary screen display of FIG. 14 having an updated and/or modified item of data accessible to one or more users.

FIG. 17 depicts the exemplary screen display of FIG. 16 when displaying a preceding version of one or more items of data rather than the most current and/or modified version.

FIG. 18 depicts an embodiment of an exemplary screen display usable to facilitate access to one or more elements of the present system.

FIG. 19 depicts a flowchart demonstrating an embodiment of an aspect the present method through which items of data can be linked to different versions of other items of data.

FIG. 20 depicts an embodiment of an exemplary screen display usable to facilitate access to one or more elements of the present system.

Embodiments of the present invention are described below with reference to the listed Figures.

### DETAILED DESCRIPTION OF THE EMBODIMENTS

Before explaining selected embodiments of the present invention in detail, it is to be understood that the present invention is not limited to the particular embodiments described herein and that the present invention can be practiced or carried out in various ways.

The present invention relates, generally, to the dissemination of data from a centralized data source, such as a server or similar data storage medium, via one or more networks, such as the Internet, or a similar network, such as a local area network, a wide area network, a satellite network, or various other types of local or worldwide public or private networks.

The data storage medium is provided with a database or similar data structure containing a plurality of items of data, which can include text, images, video or audio files, interactive questions, other similar types of data, or combinations thereof. For example, in an embodiment of the invention, the database can be used to provide educational and credentialing information to surgeons or other medical professionals, including textual chapters, audio data, images and/or videos of surgical techniques, and various quizzes or similar questions or questionnaires that can be provided for informational or self-testing purposes, or that must be answered correctly before one or more subsequent items of data can be accessed.

Access to the database is provided to one or more user devices in communication with the network. Any user device having one or more input and output means that is capable of accessing the network and transmitting and receiving data can be used within the scope of the present invention. While typical user devices can include computers, portable devices such as laptop or palmtop computers, cellular telephones, or other similar devices could also be used to access one or more portions of the database.

Each user device can be associated with a user account. For example, in various embodiments of the invention, individual users can create password protected accounts associated with a user name that can be input using any user device, or in other embodiments of the invention, recognized user devices can be provided with electronic certificates, encryption keys, or other recognition software to enable authorized user devices to access the database while preventing access to user devices lacking appropriate authentication software. In an embodiment of the invention, a user account can be associated with one or more user groups, such as a group of users accessing the database from a single workplace or a group of users enrolled in a college literature class.

When a user device accesses the database, various items of data can be transmitted to the user device for audio or visual output. In an embodiment of the invention, access to one or more items of data in the database can be restricted to selected users or selected user groups. Navigation between items of data in the database can be performed through various means known in the art, including use of search queries, hyperlinks, drop down menus, and other similar means of navigation.

To enable user customization of various items of data within the database, a user can be permitted to select one or more items of data, such as a sentence or paragraph from within a textual chapter. A user device can then be used to enter one or more notes, which are stored in the database in association with the selected items of data. For example, a user could choose to discuss a passage from a literary work, caption an image, or make informational notes relating to a video file. The user device can also be used to provide a designation to each note, possible designations typically including designations of “public,” “private,” or “group accessible.” Items of data having a note associated therewith can be displayed in a manner differing from other items of data, such as through use of colored text, highlighting, underlined, boldfaced, or italicized text, or other similar means.

User devices in communication with the database can then be used to view and access a note screen, which displays notes associated with a selected item of data, depending on the designation associated with each note. Notes provided with a “public” designation are viewable by all user devices, while notes provided with a “private” designation are only viewable by the user associated with the user account that created the note. Notes provided with a “group accessible” designation can be viewable by any user associated with the same user group as the user account from which the note originated. User accounts associated with multiple user groups can be used generate notes that are accessible to any combination of groups with which the user accounts are associated. For example, a professor making notes or references within text being distributed to students of the professor's class could provide notes accessible to a user group consisting of students and others associated with the class. In an embodiment of the invention, items of data having notes associated therewith can be displayed in a differing manner depending on the designation of the note associated therewith. For example, notes having a “private” designation and/or items of data associated therewith can be displayed with a first color, while notes having a “group accessible” designation and/or items of data associated therewith can be displayed with a second color.

In further embodiments of the invention, access to the database can be permitted by one or more administrator devices. Typically, administrator devices can be of similar type and functionality as user devices, however each administrator device is associated with an administrator account, or with one or more items of authentication software, as described previously, which identify the device as an administrator device. Through use of an administrator device, all items of data within a database and all notes associated with the data can be accessed, regardless of the designation of each note. Additionally, an administrator device is usable to select one or more items of data and input one or more administrative notes, which can be provided with designations, such as “private,” “public,” “group accessible,” “user accessible,” “administrator accessible,” or combinations thereof. Administrator notes having a “private” designation can be accessible only by the administrator account from which the administrator note originated, while administrator notes having a “public” designation can be accessed by any user device or administrator device. Administrator notes having a “group accessible” designation can be accessed by user accounts and/or administrator accounts associated with a selected user group, while administrator notes having an “administrator accessible” designation can be accessed only by administrator accounts. Administrator notes having a “user accessible” designation can be made accessible only to one or more selected user accounts.

It should be noted that the above description of features and elements usable to facilitate access, dissemination, and customization of information within the database are exemplary, and that similar means to store, access, transmit, receive, and customize data within the database can be used.

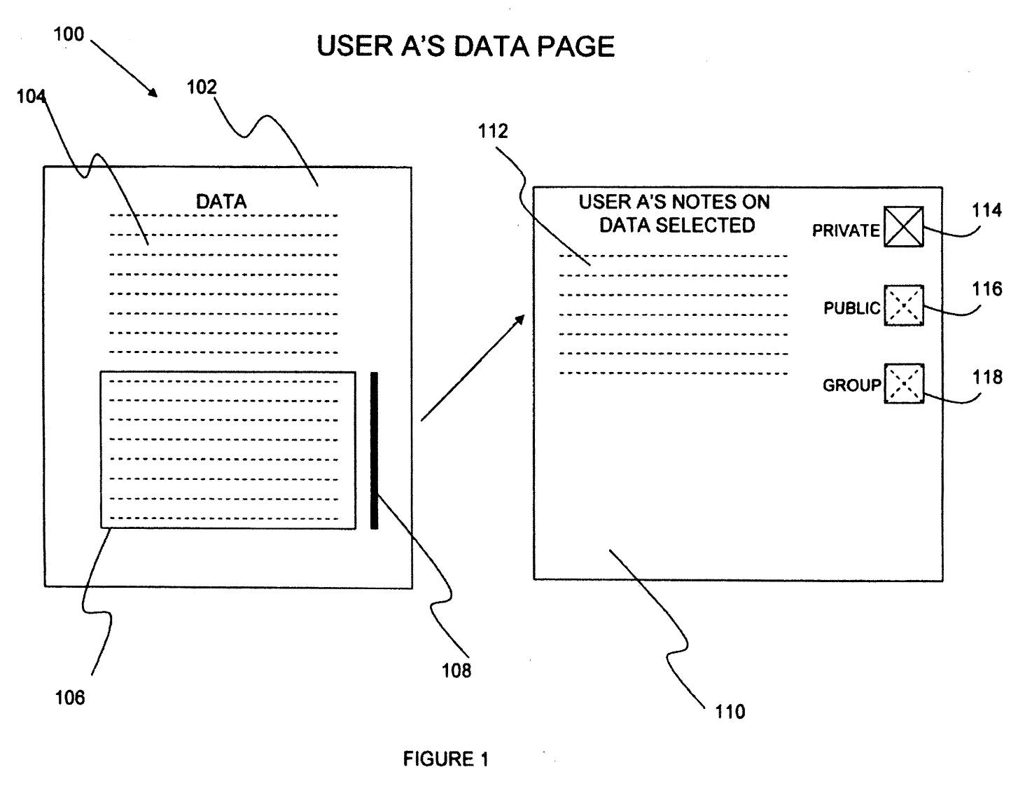

Referring now to FIG. 1, a diagram of a data exchange system (100) is shown represented by two display screens that can be transmit from the database to a user device and displayed for interactive access. The data exchange system (100) is usable to transmit items of data from the database to a user device, to receive selections of data, and to receive notes and designations from the user device for storage within the database in association with selected items of data.

The depicted data exchange system (100) is shown including a data page (102), which includes items of data (104). Specifically, the data page (102) can depict at least a portion of one or more items of data from a database. While FIG. 1 depicts the items of data (104) as dashed lines, representative of text, it should be understood that the items of data (104) can include any type of data, including, without limitation, text, images, audio files, and video files. Through the data page (102), a selection of one or more items of data (104) can be transmitted, and the selected portion (106) of data can be indicated, such as through highlighting, colored text, underlining, boldfaced or italicized text, or other markings or indications. FIG. 1 depicts a marking line (108) extending alongside the selected portion (106) of data to facilitate visualization of the selected portion (106) among the items of data (104), however it should be understood that the marking line (108) is merely an exemplary element, and that any type of visual indicator can be used, or use of a visual indicator can be omitted.

Selection of the selected portion (106) can cause a note screen (110) to be displayed, into which a user can input one or more notes (112) to be associated with the selected portion (106) of the items of data (104). The note screen (110) is also provided with selectors for indicating a designation to be associated with the one or more notes (112). Specifically, selectors are depicted for indicating a private designation (114), a public designation (116), and a group designation (118). Selection of a desired designation (114, 116, 118) causes transmission of the selected designation to the database for storage in association with the one or more notes (112) relating to the selected portion (106) of data.

In a preferred embodiment of the present invention, access to the one or more notes (112) and the ability to modify or delete the notes (112) is restricted depending on the designation selected. If a private designation (114) is selected, the content of the related notes (112) can be accessed, modified, deleted, or otherwise manipulated only by the user from which the notes (112) originated. If a public designation (116) is selected, the notes (112) can be accessed by any user, however the notes (112) cannot be changed or deleted. Alternatively, the user from which the notes (112) having the public designation (116) originated can be provided with the ability to modify or delete the notes (112). If a group designation (118) is selected, the notes (112) are only accessible to a user group to which the associated user account from which the notes (112) originated belongs. If any designation other than a private designation is selected, in further embodiments of the invention, other users can select one or more of the notes (112) and add additional notes relating to the original notes (112).

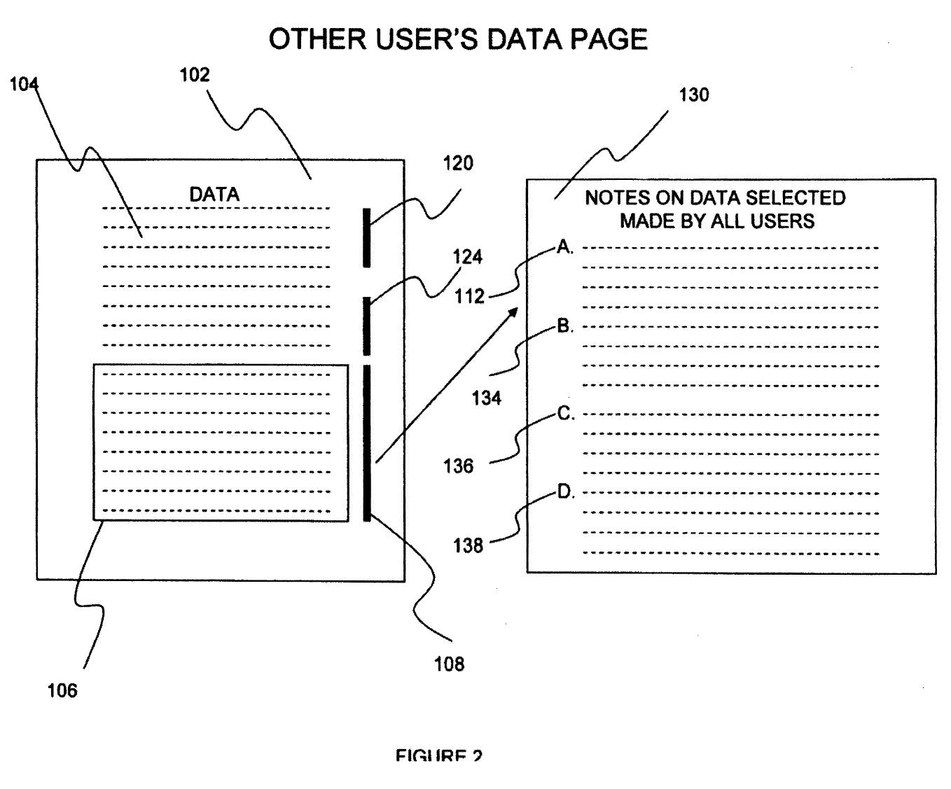

Referring now to FIG. 2, the data page (102) of FIG. 1 is shown, having numerous items of data (104), including the selected portion (106) of data with a marking line (108) adjacent thereto. FIG. 2 also depicts additional marking lines (120, 124) disposed adjacent to other portions of the items of data (104). In a preferred embodiment of the invention, portions of the data (104) having notes associated therewith are marked with a marking line, such that a user viewing the data page (102) can select any of the marking lines (108, 120, 124) and/or data associated therewith.

Selection of a marking line (108, 120, 124) and/or associated data can cause a note screen (130) associated with the selected portion of data to be displayed. The depicted note screen (130) is shown including a first note (112), a second note (134), a third note (136), and a fourth note (138). Each note (112, 134, 136, 138) can include a label identifying the user from which the note originated, and other associated information, such as the date and/or time the note was created or whether the note has been modified.

In a preferred embodiment of the invention, each user having access to a variety of notes can further customize the depicted notes by deleting notes or adding additional notes in relation to existing notes. The deletion of notes will affect only the notes received by the specific user deleting the notes, while all other users would continue to see the entirety of the accessible notes intact.

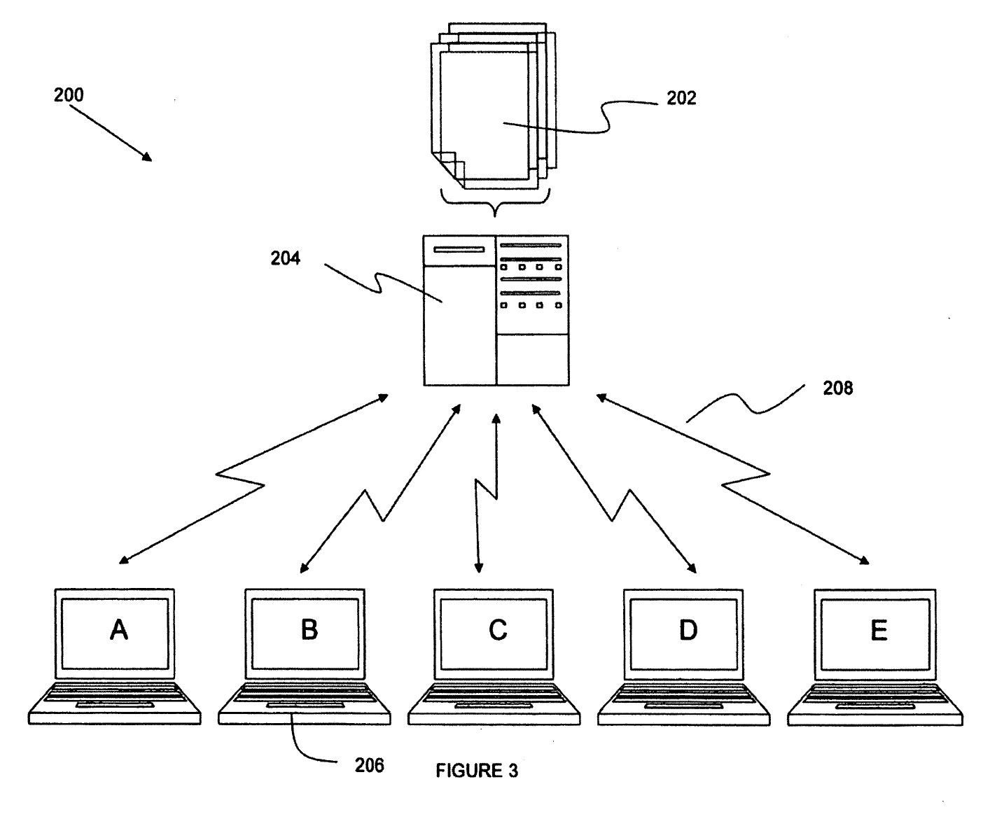

Referring now to FIG. 3, a diagram of an embodiment of the present system (200) is shown. Specifically, the system (200) is depicted having one or more items of data (202) stored within a server (204). While FIG. 3 depicts the data (202) stored within a server (204), it should be understood that various embodiments of the present invention can include use of any number and any type of data storage media, including remote, network-accessible data storage media, portable and/or removable data storage media, fixed, locally-accessible data storage media, and other similar types of data storage media. Generally, the depicted server (204) can include any computer system capable of storing data and making the data available to one or more users.

A plurality of user and/or administrator devices (206) are shown in communication with the server (204) via a networked connection (208), such as a wired or wireless Internet connection. While the user and/or administrator devices (206) are depicted as a plurality of computers, any number and any type of device usable to access the server (204), as described previously, can be utilized within the scope of the present invention. Further, while FIG. 3 depicts a networked connection (208) between the user and/or administrator devices (206) and the server (204), any combination of networked or direct connections are usable to provide access to the server (204) to any number of users, independently or simultaneously.

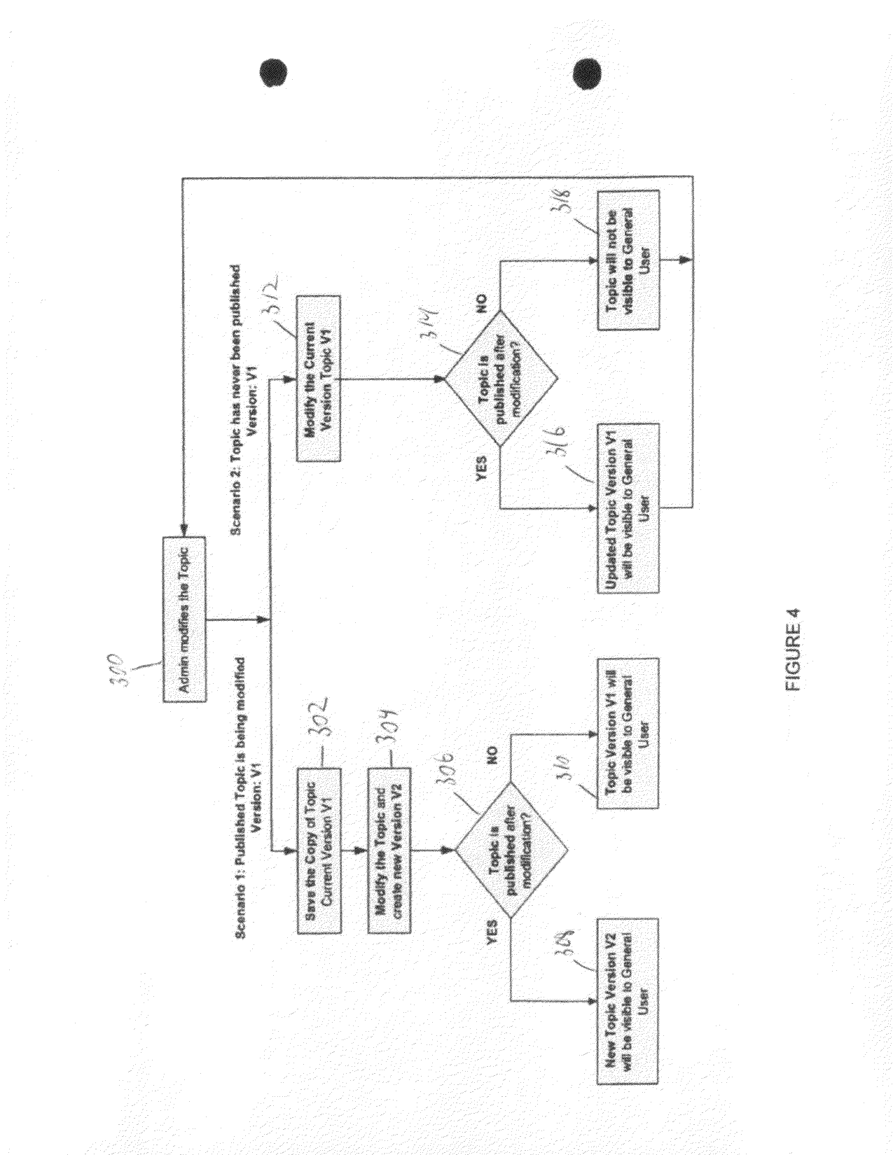

Referring now to FIG. 4, a flowchart depicting one aspect of an embodiment of the present method is shown, through which information within the database can be modified and disseminated to users with or without modifications.

In step 300, the process of dissemination is begun when an administrator device is used to access the database to create a topic that includes one or more items of data, or to modify an existing topic.

If the modified topic has been published previously, meaning that one or more items of data contained within the topic have been made available to one or more users, the current version of the topic is then saved in step 302. Modification of the topic then occurs in step 304, the modification creating a new version of the topic.

In step 306, it is then determined whether the modified topic is to be published, i.e. whether the modifications are to be made available to one or more users. If so, then the new, modified version of the topic becomes accessible to selected users, as indicated in step 308. If not, then the previously published version of the topic remains accessible to selected users, as indicated in step 310, while any modifications to the topic remain inaccessible.

If the modified topic has never before been published and made accessible to one or more users, then modifications are performed on the original version of the topic, as indicated in step 312, and no previous version of the topic is saved. It is then determined whether the modified topic is to be published, i.e. whether the modifications are to be made available to one or more users, as indicated in step 314. If so, then the modified topic becomes accessible to selected users, as indicated in step 316. If not, then the topic remains unpublished and inaccessible to users, independent of any modifications made, as indicated in step 318.

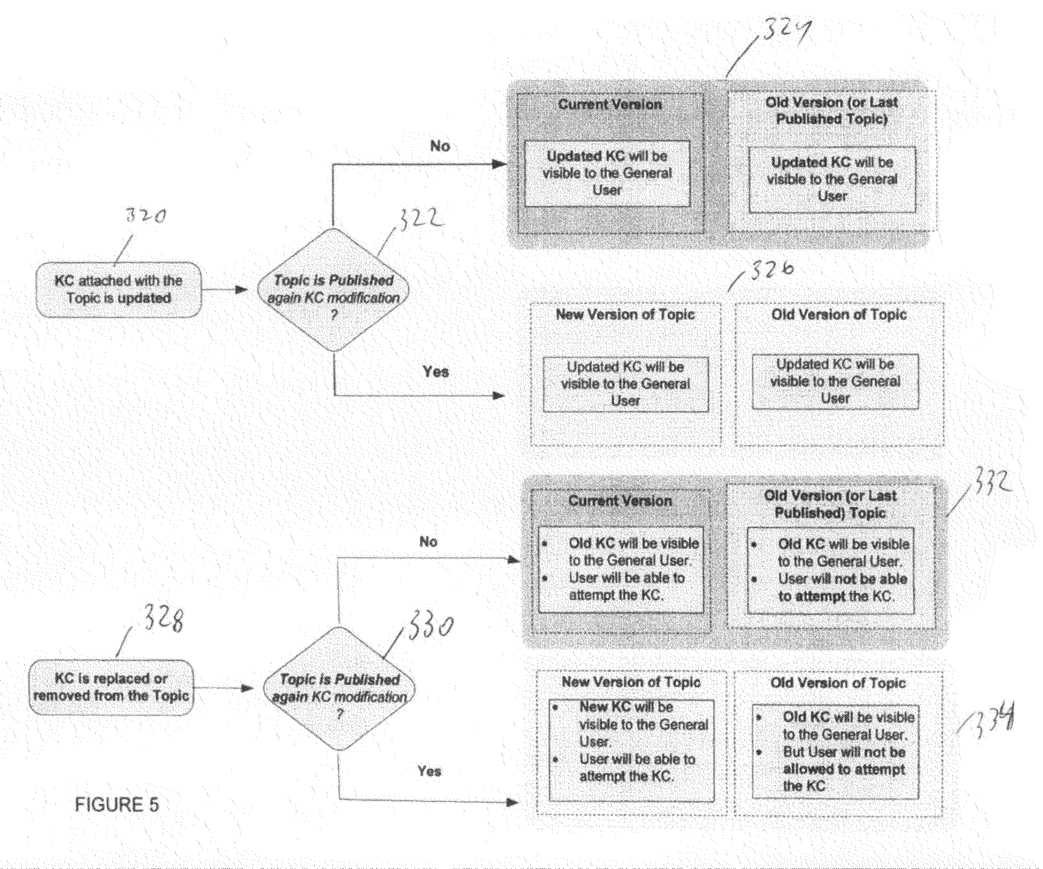

Referring now to FIG. 5, a flowchart depicting an alternate embodiment of an aspect of the present method is shown, through which information within the database can be modified and disseminated to users with or without modifications.

In the depicted embodiment of the present method, a topic is provided with an interactive questionnaire, dubbed a “Knowledge Check” (“KC”) through which the educational progress of a user can be tested. Items of data within the topic, itself, can be modified and published, or modified and not published, as described previously and depicted in FIG. 4. Additionally or independent of any modifications to the topic, itself, the KC can also be modified, updated, removed, and/or replaced.

In step 320, the KC associated with a topic is updated, such as by an administrator or a user having sufficient access and/or permissions to modify items of data within the database. In step 322, it is determined whether the topic having the modified KC is to be published, i.e. made accessible to one or more users. Independent of whether the topic is again published, however, steps 324 and 326 both indicate that the updated KC is accessible by one or more users, regardless of whether the current and/or new version of the topic is accessed, or whether the previously published version of the topic is accessed.

In step 328, the KC associated with the topic is removed or replaced. In step 330, it is determined whether the topic having the modified KC is to be published, i.e. made accessible to one or more users. If the topic is not republished, then, as indicated in step 332, when the preceding version of the topic is accessed, the preceding version of the KC will be visible to users, however users will not be able to interact with the questions of the KC. However, when the current version of the topic is accessed, the preceding version of the KC will be both visible and usable by users.

If the topic is republished, then, as indicated in step 334, when the preceding version of the topic is accessed, the preceding version of the KC will be visible to users, however users will not be able to interact with the questions of the KC. However, when the current version of the topic is accessed, the modified version of the KC will be both visible and usable by users.

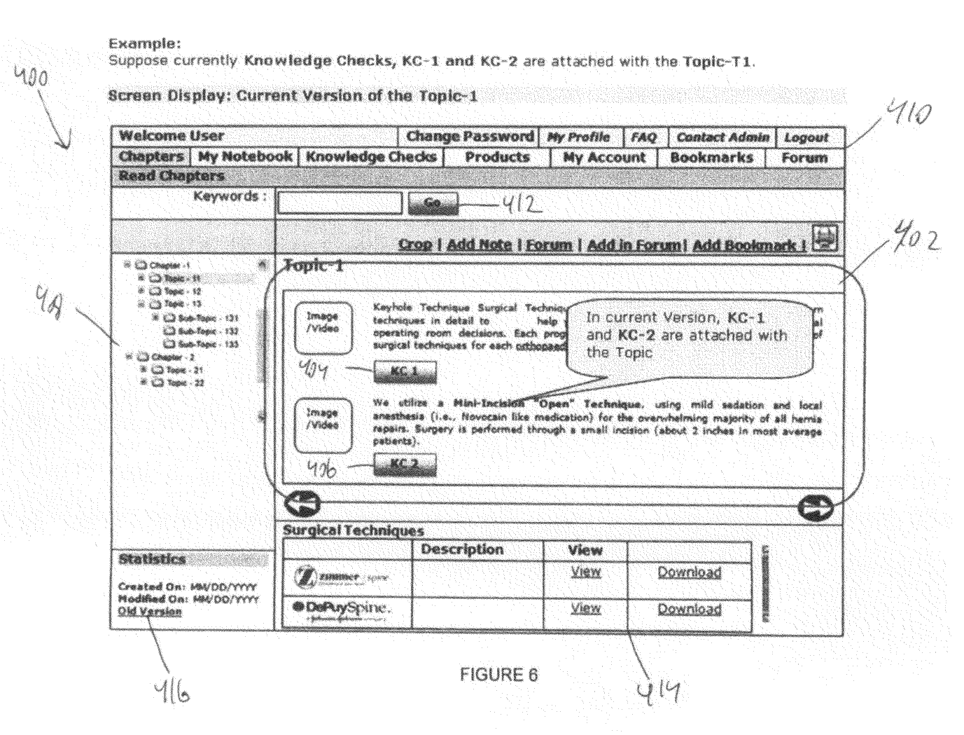

Referring now to FIG. 6, an embodiment of a screen display (400) is depicted, the screen display (400) including a content window (402) within which one or more items of data from the database can be viewed. The items of data within the content window (402) can include links or other selection members, such as selectable buttons, for quickly accessing other related items of data. For example, FIG. 6 depicts a topic having two interactive questionnaires, dubbed “KC-1” and “KC-2” associated therewith. The content window (402) is shown having a first selector button (404) for linking to the first interactive questionnaire, and a second selector button (406) for linking to the second interactive questionnaire.

The screen display (400) is also shown having a topic window (408), which depicts a list of topics that can be selected for access. Selection of a topic from the topic window (408) can cause items of data from the selected topic to appear in the content window (402).

The screen display (400) is also depicted having navigation tabs (410), which are usable to navigate between various informational and/or administrative screens relating to a user account, as well as one or more note screens relating to items of data within the database. Additionally, the screen display (400) is shown having a search query feature (412), which is usable to search one or more items of data within the database by topic, keyword, or other searchable features, and video links (414), usable to view and/or download video files provided concurrent with the items of data within the content window (402).

The screen display (400) is further shown having an “Old Version” selector (416), which is usable to access and view a previous version of depicted content when the most current version of content has been somehow modified from the preceding version. This feature can be useful when a user has partially familiarized himself or herself with items of data associated with a topic, and the topic is modified and republished before the user completes his or her review of the associated items of data.

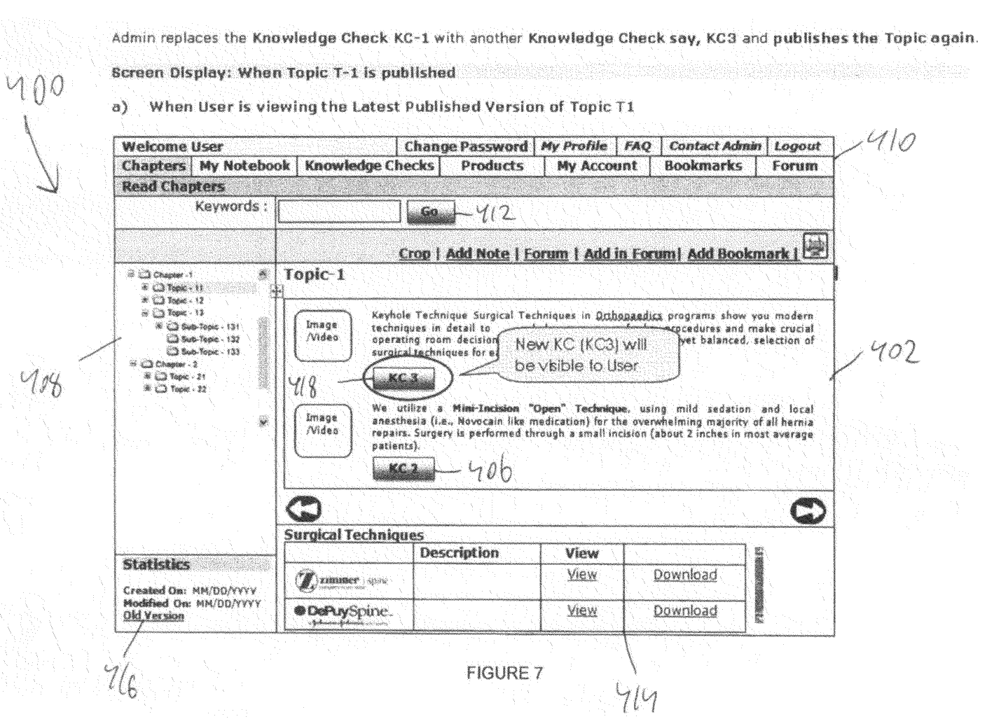

Referring now to FIG. 7, the screen display (400) of FIG. 6 is shown, with the first interactive questionnaire “KC-1” replaced, updated, and/or modified, to form a third interactive questionnaire “KC-3.” Items of data relating to the third interactive questionnaire are depicted in the content window (402), and a third selector button (418) is provided for linking to the third interactive questionnaire.

It should be noted that the screen display (400) of FIG. 6 and FIG. 7 depicts the most current, i.e. the most recently published, modified, replaced, and/or updated version of the displayed items of data within the content window (402). Previous and/or unmodified versions of the items of data can be accessed using the “Old Version” selector (416).

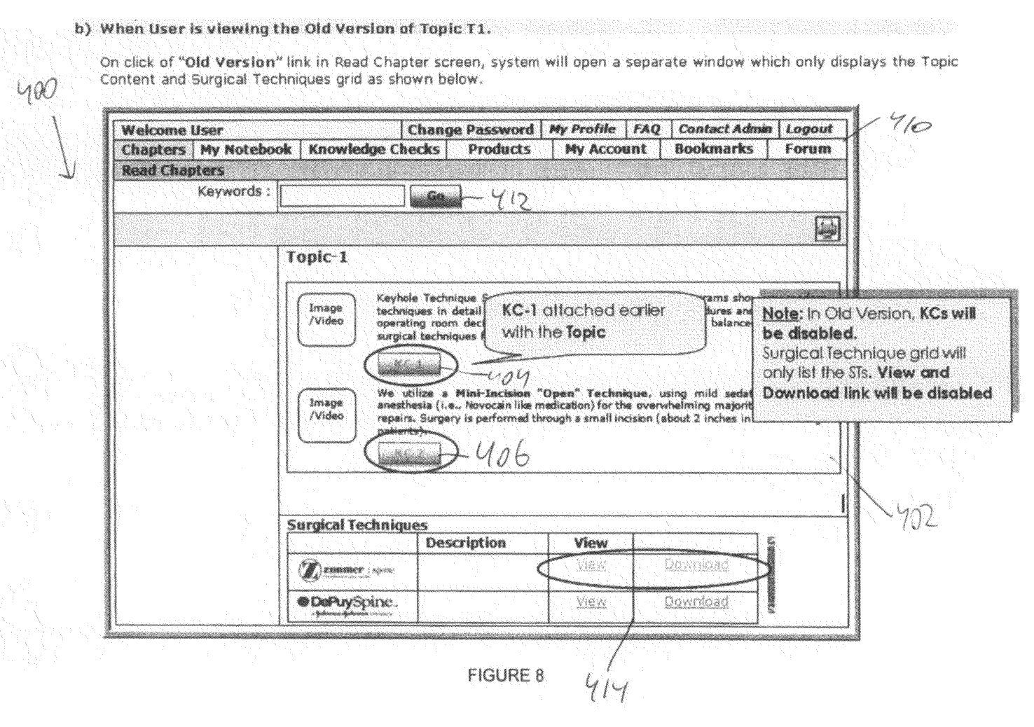

Referring now to FIG. 8, the screen display (400) of FIG. 7 is depicted after selection of the “Old Version” selector, described previously. FIG. 8 depicts the content window (402) containing items of data similar to those depicted in FIG. 6, rather than those depicted in FIG. 7. Specifically, the content window (402) is shown including the first selector (404) for linking to the first interactive questionnaire, and the second selector (406) for linking to the second interactive questionnaire. It should be noted however, that FIG. 8 depicts the first selector (404), the second selector (406), and the video links (414) as inactive. In an embodiment of the invention, when a previous, non-current version of items of data within the database is accessed, access to specific interactive elements can be restricted or prohibited.

The progression depicted in FIGS. 6 through 8 can be summarized as follows: FIG. 6 depicts an exemplary embodiment of the presentation of content to a user, while FIG. 7 illustrates the replacement of the content depicted in FIG. 6 modified and/or updated content. FIG. 8 depicts the presentation of the previous, unmodified version of content shown in FIG. 6, accessed through selection of an appropriate selector depicted in FIG. 7. Because FIG. 8 depicts a preceding version of the content, rather than the most current version shown in FIG. 7, the interactive questionnaires and video links of FIG. 8 are made viewable, but otherwise inaccessible to users.

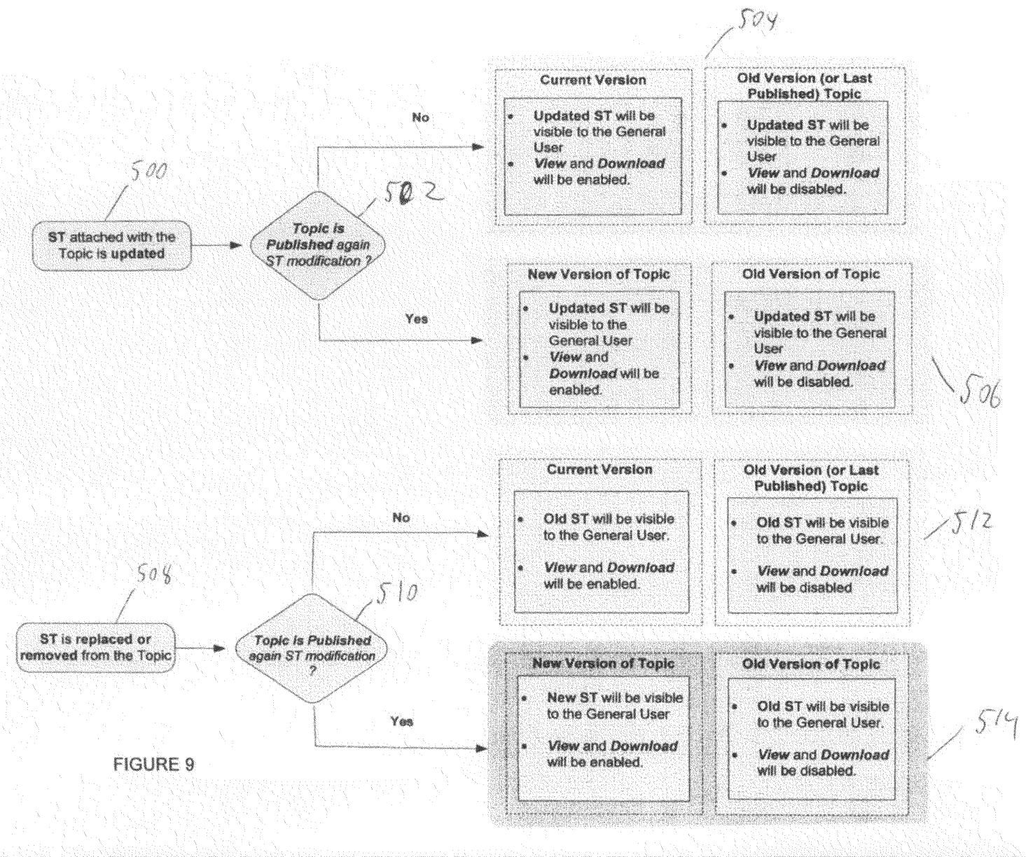

Referring now to FIG. 9, a flowchart depicting a further embodiment of an aspect of the present method is shown, through which information within the database can be modified and disseminated to users with or without modifications.

In the depicted embodiment of the present method, a topic is provided with an exemplary video file, dubbed a “Surgical Technique” (“ST”) usable to educate users regarding surgical procedures and other medical and related processes for various credentialing, certification, and informational purposes. Other items of data within the topic, itself, can be modified and published, or modified and not published, as described previously and depicted in FIG. 4. Additionally or independent of any modifications to the topic, itself, the ST can also be modified, updated, removed, and/or replaced.

In step 500, the ST associated with a topic is updated, such as by an administrator or a user having sufficient access and/or permissions to modify items of data within the database. In step 502, it is determined whether the topic having the modified ST is to be published, i.e. made accessible to one or more users. Independent of whether the topic is again published, however, steps 504 and 506 both indicate that the updated ST is visible to one or more users, regardless of whether the current and/or new version of the topic is accessed, or whether the previously published version of the topic is accessed. However, as indicated in steps 504 and 506, if the previously published version of the topic is accessed, the ability to view and/or download the updated ST can be restricted, while the ability to view and/or download the updated ST can be enabled when the current version of the topic is accessed.

In step 508, the ST associated with the topic is removed or replaced. In step 510, it is determined whether the topic having the modified ST is to be published, i.e. made accessible to one or more users. If the topic is not republished, then, as indicated in step 512, when the preceding version of the ST will be visible to one or more users, independent of whether the current or previously published version of the topic is accessed. If the previously published version of the topic is accessed, the ability to view and/or download the updated ST can be restricted, while the ability to view and/or download the updated ST can be enabled when the current version of the topic is accessed.

If the topic is republished, however, then as indicated in step 514, when the preceding version of the topic is accessed, the preceding version of the ST will be visible to users, however users will not be able to view or download the ST. When the current version of the topic is accessed, the new and/or modified version of the ST will be both visible and usable by users.

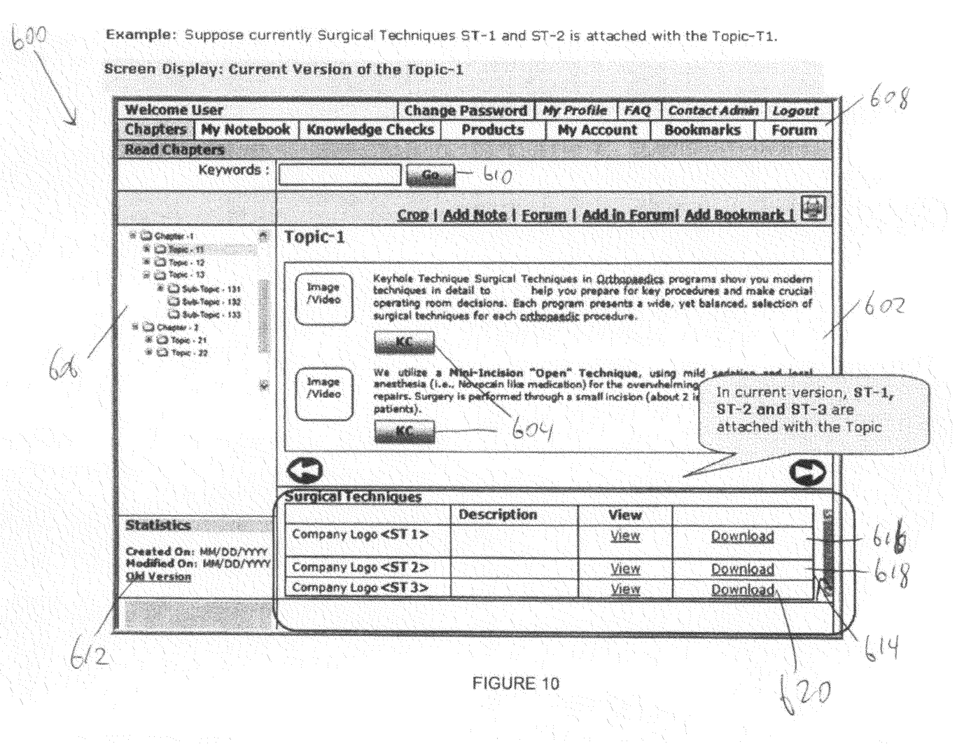

Referring now to FIG. 10, an embodiment of a screen display (600) is depicted, the screen display (600) including a content window (602) within which one or more items of data from the database can be viewed. The items of data within the content window (602) can include links or other selection members, such as selectable buttons, for quickly accessing other related items of data. For example, FIG. 10 depicts a topic having interactive questionnaires associated therewith. The content window (602) is shown having selector buttons (604) for linking to the interactive questionnaires.

The screen display (600) is also shown having a topic window (606), which depicts a list of topics that can be selected for access. Selection of a topic from the topic window (606) can cause items of data from the selected topic to appear in the content window (602).

The screen display (600) is also depicted having navigation tabs (608), which are usable to navigate between various informational and/or administrative screens relating to a user account, as well as one or more note screens relating to items of data within the database. Additionally, the screen display (600) is shown having a search query feature (610), which is usable to search one or more items of data within the database by topic, keyword, or other searchable features.

The screen display (600) is further shown having an “Old Version” selector (612), which is usable to access and view a previous version of depicted content when the most current version of content has been somehow modified from the preceding version.

FIG. 10 also depicts a video link window (614) within the screen display (600), the video link window (614) depicting the title, description, and/or other identifying information relating to an associated video file, as well as links to view and/or download the video file. Specifically, FIG. 10 depicts links to three video files relating to surgical techniques, dubbed “ST-1,” “ST-2,” and “ST-3.” A first video link (616) enables a user to view and/or download a first video file. A second video link (618) enables a user to view and/or download a second video file. A third video link (620) enables a user to view and/or download a third video file.

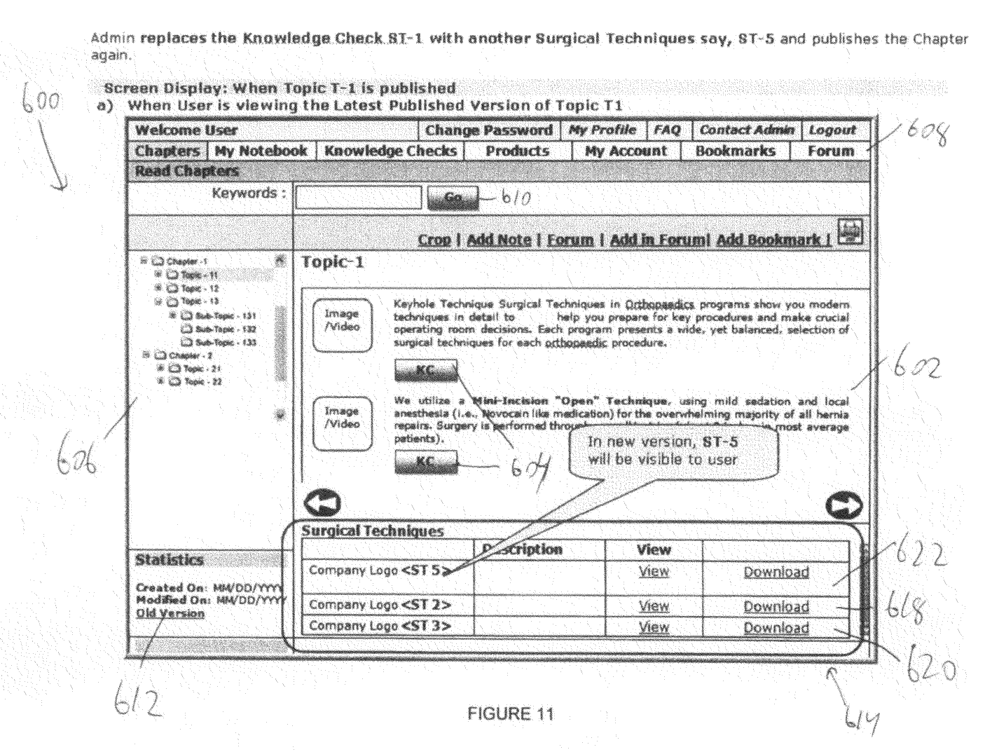

Referring now to FIG. 11, the screen display (600) of FIG. 10 is shown, with the first video file “ST-1” replaced, updated, and/or modified to form a new video file “ST-5.” Items of data relating to the new video file are shown in the content window (602), and a new selector button (622) is provided for enabling viewing and/or downloading of the new video file.

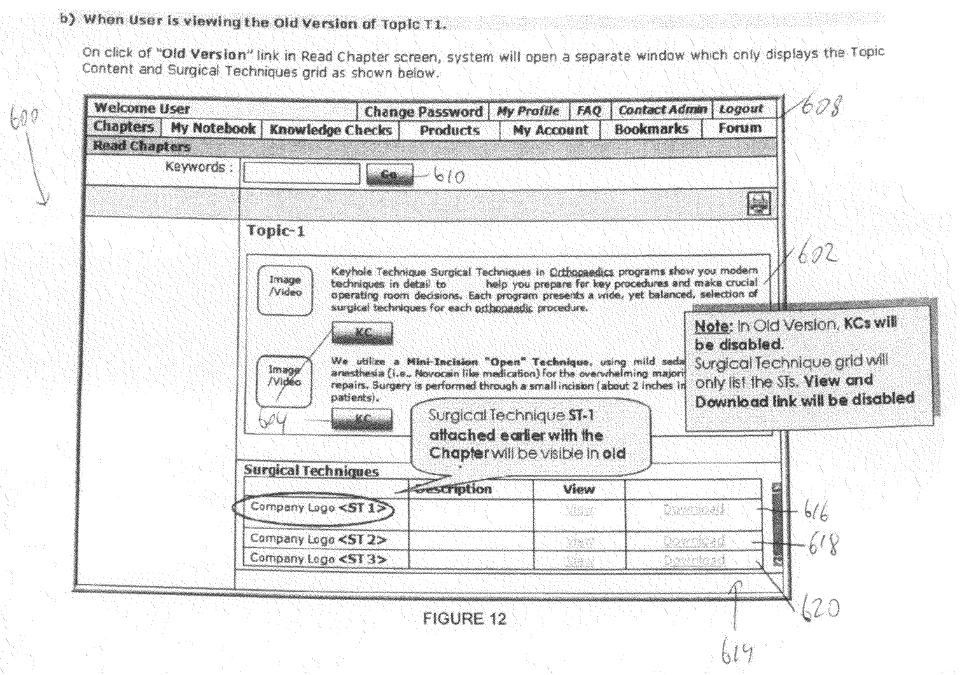

Referring now to FIG. 12, the screen display (600) of FIG. 11 is depicted after selection of the “Old Version” selector, described previously. FIG. 12 depicts the video link window (614) containing items of data similar to those depicted in FIG. 10, rather than those depicted in FIG. 11. Specifically, video link window (614) is shown including the first video link (616) for linking to the first video file, the second video link (618) for linking to the second video file, and the third video link (620) for linking to the third video file. It should be noted however, that FIG. 12 depicts the video links (616, 618, 620), as well as the selector buttons (604) for linking to the interactive questionnaires as inactive. In an embodiment of the invention, when a previous, non-current version of items of data within the database is accessed, access to specific elements can be restricted or prohibited. For example, the existence of interactive questionnaires and video files can be visible to users, however users can be restricted from accessing the questionnaires or viewing and/or downloading the video files.

The progression depicted in FIGS. 10 through 12 parallels that depicted in FIGS. 6 through 8. FIG. 10 depicts an exemplary embodiment of the presentation of content to a user, while FIG. 11 illustrates the replacement of the content depicted in FIG. 10 modified and/or updated content. FIG. 12 depicts the presentation of the previous, unmodified version of content shown in FIG. 10, accessed through selection of an appropriate selector depicted in FIG. 12. Because FIG. 12 depicts a preceding version of the content, rather than the most current version shown in FIG. 11, the interactive questionnaires and video links of FIG. 12 are made viewable, but otherwise inaccessible to users.

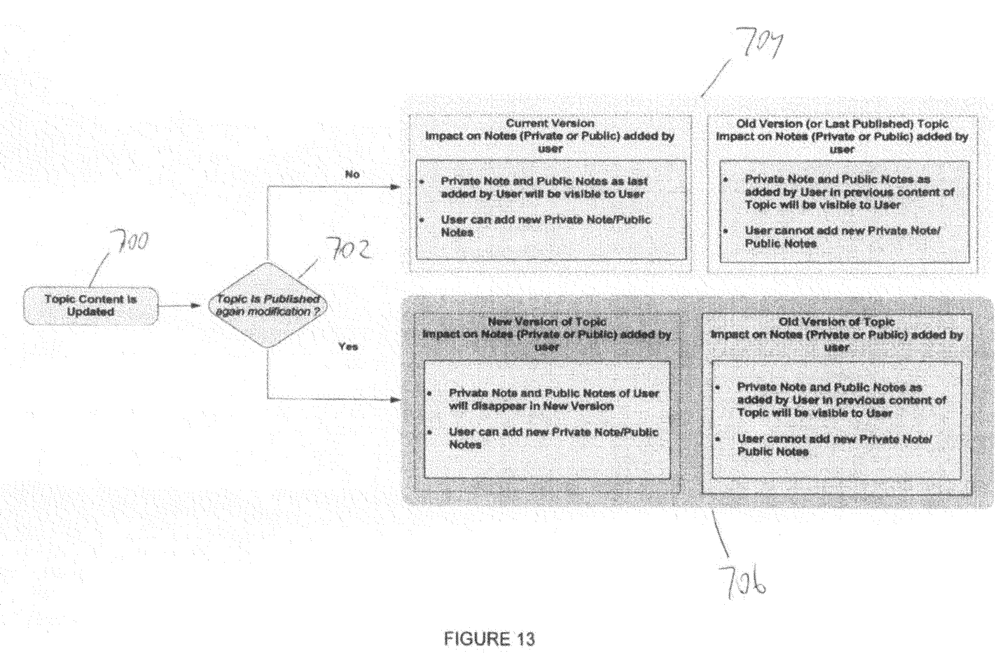

Referring now to FIG. 13, a flowchart depicting an embodiment of an aspect of the present method is shown, through which items of data within the database can be modified and disseminated to users with or without modifications.

In the depicted embodiment, a topic is provided, the topic containing one or more items of data from the database. The topic is also provided with one or more user notes and/or administrator notes associated therewith, each note having a designation, such as “public” or “private,” and other designations, as described previously. Items of data within the topic, can be modified and published, or modified and not published, as described previously and depicted in FIG. 4.

In step 700, one or more items of data within a topic are updated, such as by an administrator or a user having sufficient access and/or permissions to modify items of data within the database. Updating of items of data can include the addition of new data, removal and/or replacement of existing data, or modifications to existing data. In step 702, it is determined whether the modified is to be published, i.e. made accessible to one or more users.

If the modified topic is not republished, then, as indicated by step 704, when the current, unmodified version of the topic is viewed, notes having both public and private designations can be viewed by users, depending on the designation associated with each note, and users will have the ability to add new public or private notes. However, when viewing the previous version, which would precede the both the modified version created in step 700 and the current, unmodified version, notes associated with the previous version can be viewed by a user, but new notes associated with the previous version cannot be added.

If the modified topic is republished, then, as indicated by step 706, when the new, modified version of the topic is viewed, all notes associated with the preceding, unmodified version of the topic will not be visible, and users will have the ability to add new notes associated with the new, modified version of the topic. When the preceding, unmodified version of the topic is viewed, notes associated with the unmodified version of the topic will be visible, but users will be unable to add new notes in association with the unmodified version of the topic.

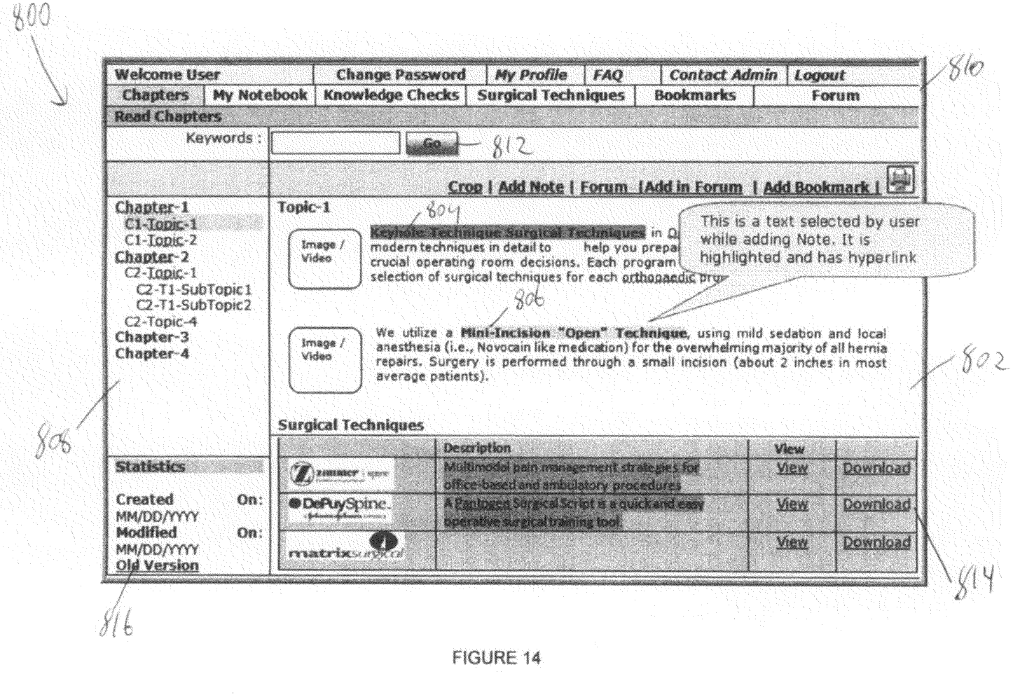

Referring now to FIG. 14, an embodiment of a screen display (800) is depicted, the screen display (800) including a content window (802) within which one or more items of data from the database can be viewed. The items of data within the content window (802) can include, without limitation, text, images, links to audio or video files, links to interactive questionnaires, other similar types of data, and combinations thereof. FIG. 14 depicts the content window (802) including text describing associated image and/or video files. Specifically, the content window (802) is shown including a first highlighted element (804) and a second highlighted element (806). The highlighted elements (804, 806) are usable to visually indicate items of data that have notes associated therewith. The highlighted elements (804, 806) can also include links to a note screen or related items of data within the database.

The screen display (800) is also shown having a topic window (808), which depicts a list of topics that can be selected for access. Selection of a topic from the topic window (808) can cause items of data from the selected topic to appear in the content window (802).

The screen display (800) is also depicted having navigation tabs (810), which are usable to navigate between various informational and/or administrative screens relating to a user account, as well as one or more note screens relating to items of data within the database. Additionally, the screen display (800) is shown having a search query feature (812), which is usable to search one or more items of data within the database by topic, keyword, or other searchable features, and video links (814), usable to view and/or download video files provided concurrent with the items of data within the content window (802).

The screen display (800) is further shown having an “Old Version” selector (816), which is usable to access and view a previous version of depicted content when the most current version of content has been somehow modified from the preceding version.

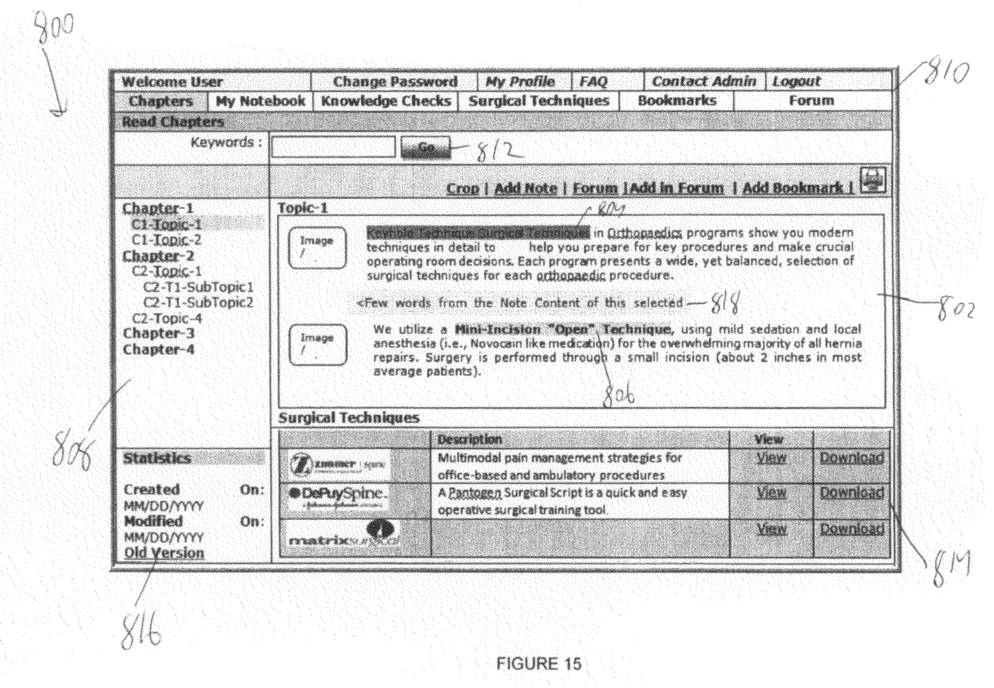

Referring now to FIG. 15, the screen display (800) of FIG. 14 is shown, with the second highlighted element (806) within the content window (802) selected, such as by placing a cursor over the second highlighted element (806) or through use of other selection methods. The depicted screen display (800) illustrates an exemplary feature usable with one or more embodiments of the invention. Selection of the second highlighted element (806) can cause a note summary (818) associated with the note indicated by the second highlighted element (806) to appear. In various embodiments of the invention, the note summary (818) can include data from the note with which it is associated, such as the first few words or sentences of content, or a summary or description of the note received concurrently with the note.

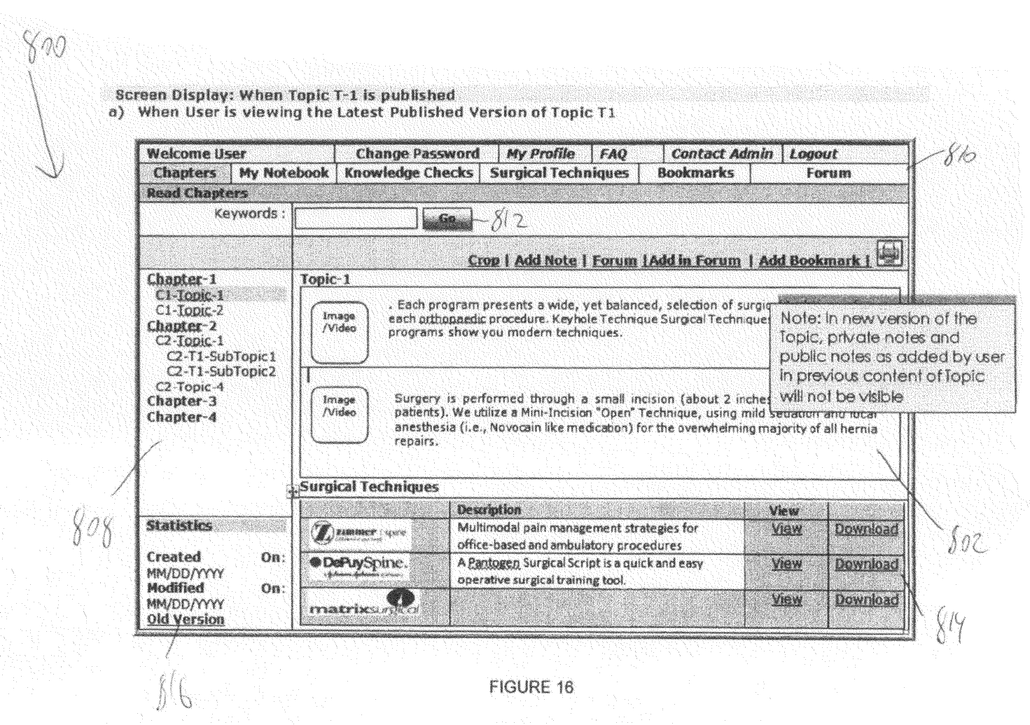

Referring now to FIG. 16, the screen display (800) of FIG. 14 is shown, with one or more items of data within the content window (802) removed, replaced, updated, and/or modified. It should be noted that in the depicted embodiment of the screen display (800), the highlighted elements (804, 806, depicted in FIG. 14) are not displayed in the content window (802) of FIG. 16, as notes associated with a preceding version of a topic are not visible when a more recent version of the topic is accessed, as depicted and described previously.

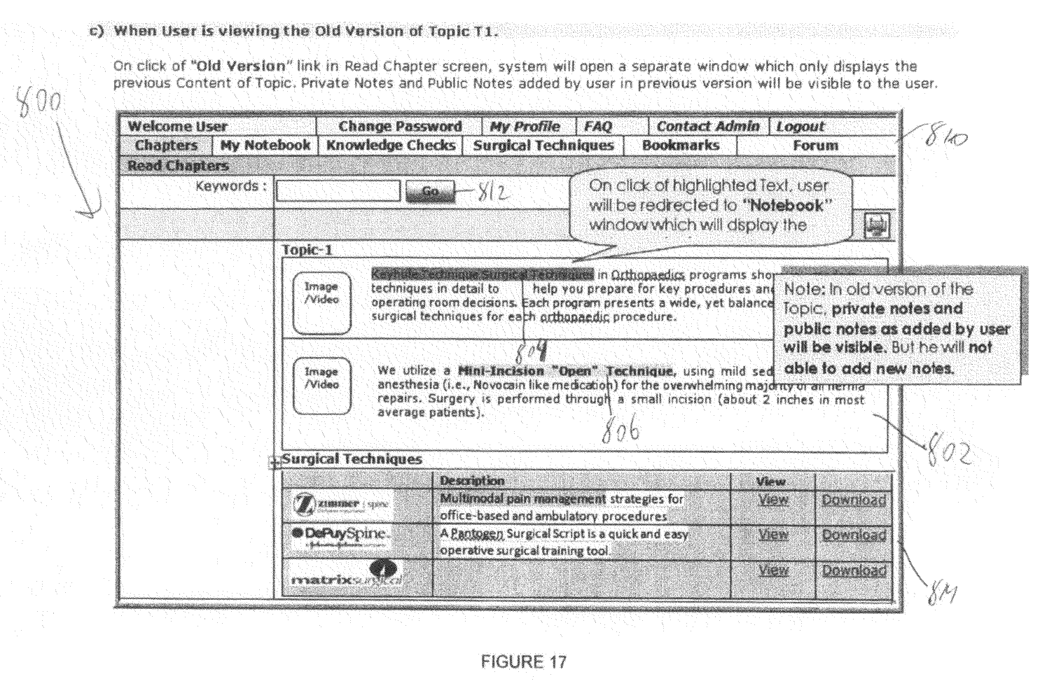

Referring now to FIG. 17, the screen display (800) of FIG. 16 is depicted after selection of the “Old Version” selector, described previously. FIG. 17 depicts the content window (802) containing items of data similar to those depicted in FIG. 14, rather than those depicted in FIG. 16. Specifically, the content window (802) is shown including the textual items of data relating to associated video files, depicted in FIG. 14, as well as the first highlighted element (804) for linking to a first note and a second highlighted element (806) for linking to a second note. It should be noted however, that while the highlighted elements (804, 806) and associated notes can be made visible, in an embodiment of the invention, the addition of new notes and/or the modification of existing notes can be restricted when a preceding version of a topic is accessed.

The progression depicted in FIGS. 14, 16, and 17 can be summarized as follows: FIG. 14 depicts an exemplary embodiment of the presentation of content to a user, while FIG. 16 illustrates the replacement of the content depicted in FIG. 14 modified and/or updated content. FIG. 17 depicts the presentation of the previous, unmodified version of content shown in FIG. 14, accessed through selection of an appropriate selector depicted in FIG. 16. Because FIG. 17 depicts a preceding version of the content, rather than the most current version shown in FIG. 16, the highlighted elements and notes can be visible to users, but users can be restricted from adding or modifying notes.

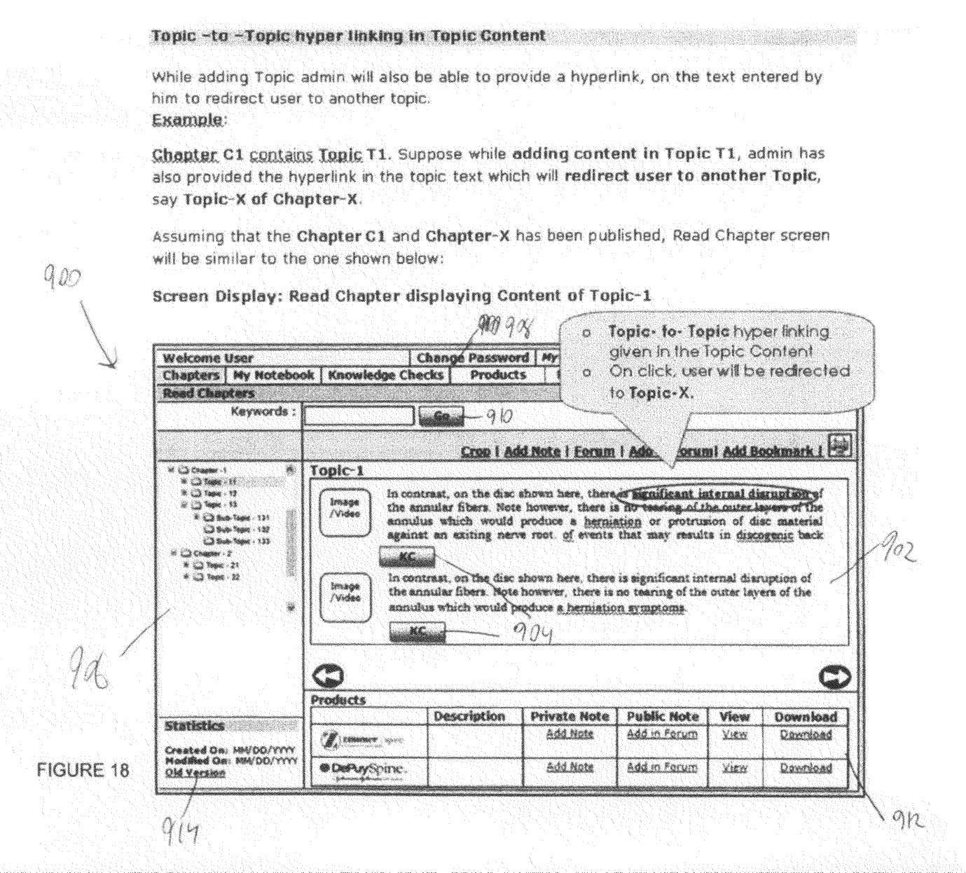

Referring now to FIG. 18, an embodiment of a screen display (900) is depicted, the screen display (900) including a content window (902) within which one or more items of data from the database can be viewed. The content window is shown including selector buttons (904) for linking to interactive questionnaires, in addition to other items of data.

The screen display (900) is also shown having a topic window (906), which depicts a list of topics that can be selected for access. Selection of a topic from the topic window (906) can cause items of data from the selected topic to appear in the content window (902).

The screen display (900) is also depicted having navigation tabs (908), which are usable to navigate between various informational and/or administrative screens relating to a user account, as well as one or more note screens relating to items of data within the database. Additionally, the screen display (900) is shown having a search query feature (910), which is usable to search one or more items of data within the database by topic, keyword, or other searchable features, and video links (912), usable to view and/or download video files provided concurrent with the items of data within the content window (902).

The screen display (900) is further shown having an “Old Version” selector (914), which is usable to access and view a previous version of depicted content when the most current version of content has been somehow modified from the preceding version.

In the depicted embodiment, the content window (902) of the screen display (900) is shown including a hyperlink (916), usable to link to other items of information in the database, such as topics relating to information displayed in the content window (902). Upon selection of the hyperlink (916), the items of data with which the hyperlink (916) is associated can be displayed in the content window (902), provided the associated items of data are accessible, as described below.

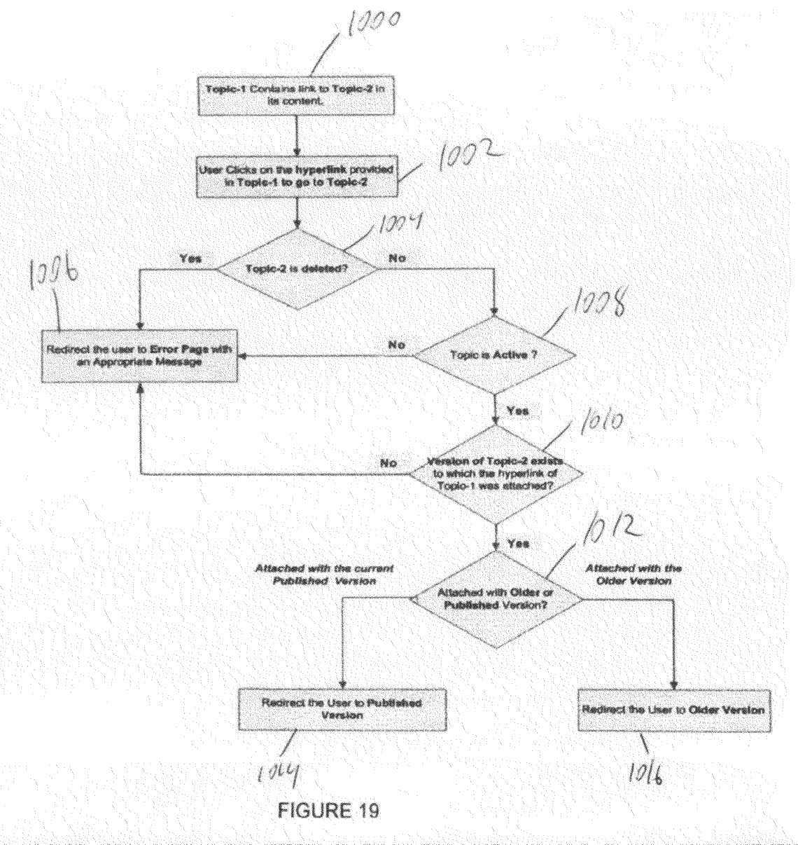

Referring now to FIG. 19, a flowchart is shown, depicting an aspect of an embodiment of the present method relating to the linking of selected items of data within the database to other selected items of data.

In step 1000, a first topic is provided, the first topic containing a link to a selected version of a second topic within the content of the first topic. In step 1002, selection of the link is received from a user device in communication with the database. As indicated in step 1004, it is then determined whether the second topic has been deleted or otherwise made inaccessible. If so, an error can be displayed with an appropriate message, as indicated in step 1006.

If the second topic has not been deleted or otherwise made inaccessible, it is then determined whether the second topic is currently active, i.e. accessible to the user account from which a selection of the link has been received, as indicated in step 1008. If the second topic is not active, an error can be displayed with an appropriate message, as indicated in step 1006. If the second topic is active, it is further determined whether the selected version of the second topic with which the link is associated exists and has not been replaced or otherwise made inaccessible, as indicated in step 1010.

If it is determined that the second topic has not been deleted or otherwise made inaccessible, the second topic is active, and the selected version of the second topic with which the link is associated exists and is accessible, it is then determined whether the selected link is associated with the current, published version of the second topic, or with a previous version, as indicated in step 1012. If the link is associated with the current version of the second topic, then access is provided to the current version, as indicated in step 1014. If the link is associated with an older version of the topic, then access is provided to the older version, as indicated in step 1016.

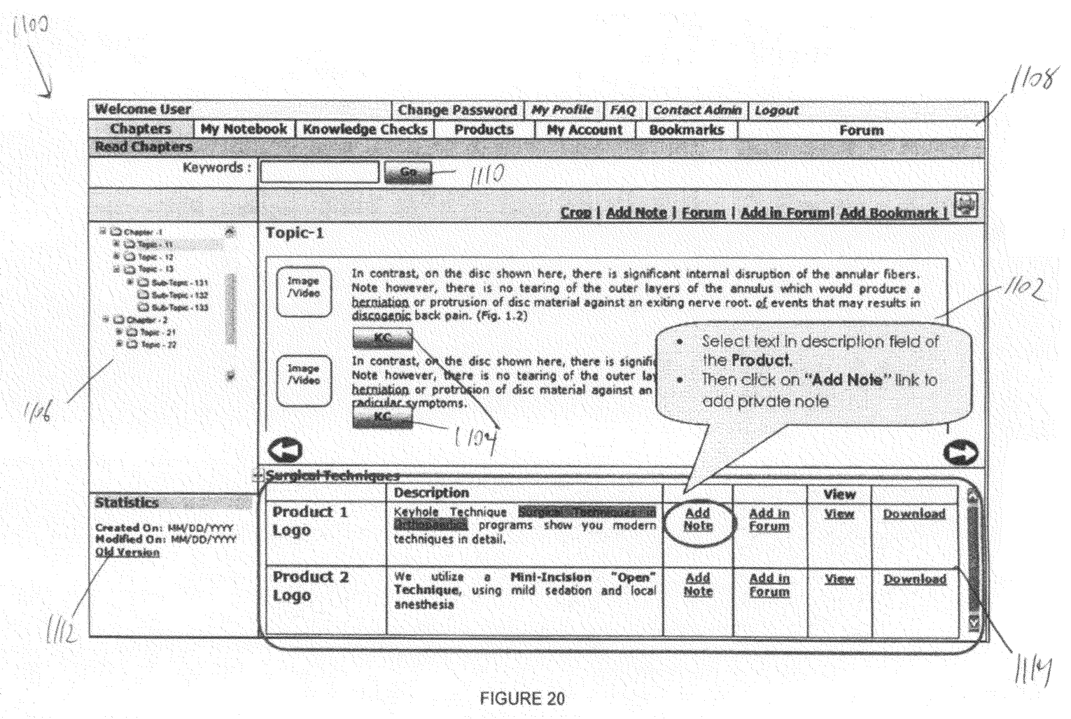

Referring now to FIG. 20, an embodiment of a screen display (1100) is depicted, the screen display (1100) including a content window (1102) within which one or more items of data from the database can be viewed. The items of data within the content window (1102) can include links or other selection members, such as selectable buttons, for quickly accessing other related items of data. For example, FIG. 20 depicts a topic having interactive questionnaires associated therewith. The content window (1102) is shown having selector buttons (1104) for linking to the interactive questionnaires.

The screen display (1100) is also shown having a topic window (1106), which depicts a list of topics that can be selected for access. Selection of a topic from the topic window (1106) can cause items of data from the selected topic to appear in the content window (1102).

The screen display (1100) is also depicted having navigation tabs (1108), which are usable to navigate between various informational and/or administrative screens relating to a user account, as well as one or more note screens relating to items of data within the database. Additionally, the screen display (1100) is shown having a search query feature (1110), which is usable to search one or more items of data within the database by topic, keyword, or other searchable features.

The screen display (1100) is further shown having an “Old Version” selector (1112), which is usable to access and view a previous version of depicted content when the most current version of content has been somehow modified from the preceding version.

FIG. 20 also depicts a video link window (1114) within the screen display (1100), the video link window (1114) depicting the title, description, and/or other identifying information relating to an associated video file, as well as links to view and/or download the video file. In the depicted exemplary screen display (1100), FIG. 20 also shows note links (1116), usable to directly add notes associated with the content displayed in the video link window (1114). The note links (1116) are usable individually or in combination with other methods for selecting items of data and associating notes therewith.

With respect to public notes, the ability to allow the admin to create a note within the content that is viewable by all users within that client is provided. When logged on as an admin, the ability to enter the IEP and view it as a user is available. This works similar to entering a user's console. This ability is accomplished by entering the Public Notes section of the admin tools. Upon clicking the “Public Notes” section of the admin module, the admin should have two tabs: Chapters and Notebook. After selecting a particular chapter, one can navigate exactly like a user logged into the IEP. From here the admin can enter a section of the IEP and make notes. These notes made will then become “Public Notes.” The functionality works like how a user would make notes, involving highlighting and adding images or animations. Once the note is complete it then show up on the admin's Notebook tab. In addition, these notes will then become viewable within a user's public notebook as well as within the IEP content. These public notes only show up within a particular IEP-Client instance. For example, public notes within an IEP-Client Nuvasive will only appear to this Client's users. The IEP admin section will be similar or the same for all admins.

Public Notes Scenario: Admin-1 goes into the Public Notes section and adds a new Public Note, PN-1. Then, if Admin-2 goes into the Public Notes section, PN-1 should appear within the notebook as well as highlighted within the IEP content. Admin-2 can also remove and edit notes that he did not create.

The users side is related. On pages with an admin note, the user will be able to see an icon that will allow for toggling of the types of notes that are displayed on the page. By clicking the icon, the user's personal notes should disappear and only the admin notes should be visible. These should be emphasized using a different coror of highlighting or some other technique. By clicking the icon again, user notes reappear and admin notes should again be disabled and invisible.

When in public note view, the user is be able to select or mouse over the note and have a popup window appear like how the notes currently function. The user should be able to click the link and view the note. The user should not be able to edit the note or make changes to it. A user's notebook has a new link within it called “Public Notes” that will direct him to a page containing all public notes. The public notebook will function exactly like the user's private notebook, only without the edit and delete columns as they will not have this ability. General users can private a note with the Topic Text, and these notes will not be visible to other general users and the administrator. Step 3: Select the Text in the Topic Content to add the private note. Step 4: As soon as the user selects some text in Topic Content and clicks on Add Note link, then an appropriate screen will be provided to the user for adding Clips saved in the Clipboard and also to preview the note content in HTML format.

The steps followed by user for adding private note in the Topic are as follows. Step 1: Access the Read Chapter module by selecting any Chapter or Topic in the Chapters screen. Step 2: As soon as the user selects any Chapter or Topic, the Read Chapter will display the content of the selected Topic.

To Add Clip in the Notes Content, as soon as the user clicks on the “Add Clip” button, the user will be provided with the Clipboard screen which will show the images/vidoes added by the user in the current session. Using Clipboard window, user can perform following activities: Add the Image/Video in the notes content by clicking on (+) sign given besides each clip; Add more Image/Video in the Clipboard from his local PC by clicking on “Get Files from Desktop” button; and Add more Image/Video in the Clipboard from the web by clicking on “Get Files from Web.”

To preview the Notes content, when the user clicks on the Preview button in Add Notes screen, system will open notes content in separate HTML page. If user has added Video in the notes content, then video will be displayed playing in Windows Media Player. Then, click on the Save button in the Add Note screen, and the private note of the user will be saved.

To read the Chapter screen once the user has added his private note, the text selected by user while adding note will be highlighted with different color with a hyperlink on it. Hover the mouse on the highlighted text, and the system will provide a pop-up window which will display some of the characters from the Notes content added by the user for this particular text. Then, click on the hyperlink provided on the highlighted text, the user will be redirected to screen similar to Add Note which will be displaying the notes relevant to the highlighted text.

It should be noted that the capabilities, elements, and features of the interactive systems and methods described herein are exemplary, and that the present systems and methods can include any combination of various similar features and means of implementation. As such, while various embodiments of the present invention have been described with emphasis, it should be understood that within the scope of the appended claims, the present invention might be practiced other than as specifically described herein.

What is claimed is:

1. A method for disseminating data to a plurality of users and enabling user customization of the data, the method comprising the steps of:
providing a data storage medium comprising a database containing a plurality of items of data, wherein the data storage medium is in communication with a network;
permitting access to the database to a user device in communication with the network, wherein the user device is associated with a user account, and wherein the user account is associated with at least one user group;
receiving selection of at least one of the items of data from the user device;
receiving at least one note from the user device, associating said at least one note with said at least one of the items of data, and storing said at least one note in the database;
receiving a designation from the user device relating to said at least one note, wherein the designation is selected from the group consisting of: public, private, group accessible, and combinations thereof and storing the designation in the database in association with said at least one note; and
transmitting to the user device a user note screen associated with said at least one of the items of data, wherein the user note screen comprises: notes comprising a public designation, notes associated with the user account and comprising a private designation, and notes associated with said at least one user group and comprising a group accessible designation.

2. The method of claim 1, wherein the step of permitting access to the database to the user device comprises displaying at least a portion of the plurality of items of data on the user device, wherein said at least one of the items of data having said at least one note associated therewith is displayed in a manner distinct from each other item of said at least a portion of the plurality of items of data.

3. The method of claim 1, wherein the plurality of items of data comprise text, images, video output, audio output, interactive questions, or combinations thereof.

4. The method of claim 1, wherein said at least one note comprises text, images, video output, audio output, or combinations thereof.

5. The method of claim 2, wherein the displaying of said at least a portion of the plurality of items of data on the user device comprises displaying items of data associated with notes comprising a public designation in a first manner, items of data associated with notes comprising a private designation and associated with the user account in a second manner, and items of data associated with a note comprising a group accessible designation and associated with said at least one user group in a third manner.

6. The method of claim 1, further comprising the steps of:
permitting access to the database to an administrator device in communication with the network;
receiving selection of at least one of the items of data from the administrator device;
receiving at least one administrative note from the administrator device, associating said at least one administrative note with said at least one of the items of data, and storing said at least one administrative note in the database;
receiving a designation from the administrator device relating to said at least one administrative note, wherein the designation is selected from the group consisting of: public, private, group accessible, user accessible, administrator accessible, and combinations thereof and storing the designation in the database in association with said at least one note; and
transmitting to the administrator device an administrator note screen associated with said at least one of the items of data, wherein the administrator note screen comprises: notes comprising a public designation, a private designation, a group accessible designation, an administrator accessible designation, a user accessible designation, or combinations thereof,
wherein the user note screen associated with said at least one of the items of data further comprises: notes comprising a user accessible designation.

7. The method of claim 1, further comprising the steps of:
storing within the data storage medium at least one of the plurality of items within the database as a first version of a topic;
permitting addition, removal, modification, or combinations thereof, of said at least one of the plurality of items of data to form a second version of the topic; and
selectively transmitting the first version of the topic to the user device while preventing access to the second version of the topic to the user device, transmitting the second version of the topic to the user device while preventing access to the first version of the topic to the user device, or receiving from the user device a selection of the first version of the topic or the second version of the topic and transmitting the first version of the topic or the second version of the topic to the user device based on the selection.

8. The method of claim 7, wherein the step of receiving from the user device a selection of the first version of the topic or the second version of the topic comprises:
transmitting the second version of the topic to the user device, wherein the second version of the topic comprises a selection member accessible by the user device to cause transmission of the first version of the topic;
receiving selection of the selection member from the user device; and
transmitting the first version of the topic to the user device responsive to the selection of the selection member.

9. A system for disseminating data to a plurality of users and enabling user customization of the data, the system comprising:
a data storage medium in communication with a network, wherein the data storage medium comprises a database, and wherein the database comprises:
a plurality of items of data for access by users,
a plurality of user accounts,
at least one administrator account,
a plurality of notes, wherein each note is stored in association with at least one of the plurality of items of data;
a plurality of designations, wherein each designation is stored in association with at least one of the plurality of notes, and wherein each of the plurality of designations is selected from the group consisting of: public, private, group accessible, user accessible, administrator accessible, and combinations thereof;
a plurality of user devices in communication with the database via the network, wherein the plurality of user devices receives from the database at least a portion of the plurality of items of data, notes comprising a public designation, notes associated with the user account and comprising a private designation, notes associated with said at least one user group and comprising a group accessible designation, and notes comprising a user accessible designation, and wherein the plurality of user devices transmits to the database selection of at least one of the items of data, at least one note for storage in association with said at least one of the items of data, and a designation for storage in association with said at least one note, wherein the designation is selected from the group consisting of public, private, group accessible, and combinations thereof; and
at least one administrator device in communication with the database via the network, wherein said at least one administrator device receives from the database at least a portion of the plurality of items of data and notes associated with said at least a portion of the plurality of items of data, and wherein said at least one administrator device transmits to the database selection of at least one of the items of data, at least one administrator note for storage in association with said at least one of the items of data, and an administrator designation for storage in association with said at least one administrator note, wherein the administrator designation is selected from the group consisting of public, private, group accessible, user accessible, administrator accessible, and combinations thereof.

10. The system of claim 9, further comprising a processor in communication with the network, wherein the database further comprises:
computer instructions for instructing the processor to receive a selection of said at least a portion of the plurality of items of data from the plurality of user devices, said at least one administrator device, or combinations thereof; and
computer instructions for instructing the processor to receive and store said at least one note, said at least one administrator note, the designation, the administrator designation, or combinations thereof.

11. The system of claim 9, further comprising a processor in communication with the network, wherein the database further comprises computer instructions for instructing the processor to display items of data having said at least one note, said at least one administrator note, or combinations thereof, associated therewith is displayed in a manner distinct from each other item of said at least a portion of the plurality of items of data.

12. The system of claim 11, wherein computer instructions for instructing the processor to display items of data further instruct the processor to display items of data associated with notes comprising a public designation in a first manner, items of data associated with notes comprising a private designation or user accessible designation in a second manner, items of data associated with a note comprising a group accessible designation and associated in a third manner, and items of data associated with a note comprising an administrator accessible designation in a fourth manner.

13. The system of claim 9, wherein the plurality of items of data comprise text, images, video output, audio output, interactive questions, or combinations thereof.

14. The system of claim 9, wherein said at least one note, said at least one administrator note, or combinations thereof, comprises text, images, video output, audio output, or combinations thereof.

15. The system of claim 9, wherein the plurality of items of data comprise a first version of a topic and a second version of a topic, wherein the system further comprises a processor in communication with the network, and wherein the database further comprises computer instructions for instructing the processor to: transmit the first version of the topic to the user device while preventing access to the second version of the topic to the user device, transmit the second version of the topic to the user device while preventing access to the first version of the topic to the user device, receive from the user device a selection of the first version of the topic or the second version of the topic and transmit the first version of the topic or the second version of the topic to the user device based on the selection, or combinations thereof.

16. The system of claim 15, wherein the computer instructions further instruct the processor to transmit the second version of the topic to the user device, transmit a selection member accessible by the user device to cause transmission of the first version of the topic, receive selection of the selection member from the user device, and transmit the first version of the topic to the user device responsive to the selection of the selection member.
